(19) United States
(12) Patent Application Publication
(10) Pub. No.: US 2012/0183839 A1
(43) Pub. Date: Jul. 19, 2012

(54) LITHIUM SECONDARY BATTERY AND CATHODE FOR A LITHIUM SECONDARY BATTERY

(76) Inventors: Toyotaka Yuasa, Hitachi (JP); Mituru Kobayasi, Hitachiota (JP); Sai Ogawa, Tokai (JP)

(21) Appl. No.: 13/257,693

(22) PCT Filed: Jul. 28, 2010
(86) PCT No.: PCT/JP2010/004787

§ 371 Date: Oct. 21, 2011

(30) Foreign Application Priority Data
Sep. 30, 2009 (JP) 2009-225946

(51) Int. Cl. H01M 4/525; H01M 4/131; H01M 2/20; H01M 4/04; H01M 4/505; H01M 10/05; B82Y 30/00

(52) U.S. Cl. 429/158; 429/224; 429/221; 427/126.1; 977/773

(57) ABSTRACT

The present invention provides a high-output lithium secondary battery. A cathode for lithium ion secondary battery of the present invention is used for a lithium secondary battery including a non-aqueous electrolyte solution. The cathode includes a complex oxide having an olivine structure represented by a chemical formula LiₐMₓPO₄ (0<a≦1.2, 0.9≦x≦1.1, and M is a transition metal including Fe or Mn), where a peak intensity ratio (I₍₀₂₀₎/I₍₁₀₁₎) between (020) and (101) of the cathode measured by X-ray diffraction using Cu—Kα radiation is 3.5 or more and 4.2 or less, and is preferably 3.8 or more and 4.2 or less. Preferably, the cathode material has a primary particle diameter of between 20 nm and 200 nm, and a specific surface area of between 10 m²/g and 30 m²/g.

### TECHNICAL FIELD

The present invention relates to a lithium secondary battery that includes a non-aqueous electrolyte solution, particularly, relates to a cathode for a lithium secondary battery.

### BACKGROUND ART

A lithium secondary battery for automotives requires high output (reduction in battery resistance) and high safety. In a cathode active material having an olivine structure including Fe or Mn as a transition metal (LiMO₄, M is a transition metal including Fe or Mn. The cathode active material having an olivine structure is hereinafter abbreviated as an olivine cathode material), bond of oxygen and phosphorus in the crystal structure is strong and the oxygen is difficult to be released from the crystal structure at the time of overcharge. Therefore this cathode active material has high safety.

Non-Patent Document 1 discloses that lithium ions in an olivine cathode material diffuse in one dimension along a direction of b axis of the crystal. Patent Document 1 discloses a method for synthesizing LiFePO₄ (hereinafter abbreviated as an olivine iron), an electrode including the olivine iron and a method for manufacturing a coin-shaped lithium battery, and also discloses evaluation of the characteristics. Patent Document 2 discloses a method for manufacturing an olivine iron by using a fusion method.

### PRIOR ART DOCUMENTS

### Patent Documents

Patent Document 1: Japanese Patent Application Publication No. Hei 9-134725
Patent Document 2: Japanese Patent Application Publication No. 2005-155941

### Non-Patent Documents

Non-patent Document 1: Nature Materials 7, 707-711 (2008)

### DISCLOSURE OF THE INVENTION

### Problem to be Solved by the Invention

A lithium secondary battery requires further high output. An object of the present invention is to provide a high-output lithium secondary battery by improving the olivine cathode material.

### Means for Solving the Problem

The present invention, which solves the above problem, relates to a cathode for a lithium secondary battery that includes a non-aqueous electrolyte solution. The cathode for the lithium ion secondary battery has a cathode mixture layer including a cathode active material on a current collector. The cathode for a lithium ion secondary battery of the present invention includes a complex oxide having an olivine structure represented by a chemical formula LiₐMₓPO₄ (0<a≦1.2, 0.9≦x≦1.1, and M is a transition metal including Fe or Mn), where a peak intensity ratio (I₍₀₂₀₎/I₍₁₀₁₎) between (020) and (101) of the cathode measured by X-ray diffraction using Cu—Kα radiation is 3.5 or more and 4.2 or less, and is preferably 3.8 or more and 4.2 or less.

Preferably, the cathode material has a primary particle diameter of between 20 nm and 200 nm, and a specific surface area of between 10 m²/g and 30 m²/g. Preferably, an aspect ratio of primary particles in the cathode material, ((a length in a direction of a axis or c axis)/(a thickness in a direction of b axis)) is 1.2 or more and 2.5 or less, and more preferably, is 2.1 or more and 2.5 or less.

The present invention, which solves the above problem, relates to a lithium secondary battery including the above-mentioned cathode. The lithium secondary battery can be used for a battery module that includes a plurality of electrically connected lithium secondary batteries.

### Advantageous Effect of the Invention

According to the present invention, a high-output secondary battery can be provided by lowering the resistance of the cathode.

### BRIEF DESCRIPTION OF THE DRAWINGS

FIG. 1 is a graph showing a relation between a crystalline orientation and electrode resistance of a cathode active material in a cathode;

FIG. 2 is a cross-sectional view of a cathode showing an orientation of a high-density flat active material in the cathode; and

FIG. 3 is a partial cross-sectional view of a cylindrical lithium secondary battery.

### BEST MODES FOR CARRYING OUT THE INVENTION

A high-output and high energy density battery is required for an electric power source of a hybrid vehicle in which energy can be effectively used. A lithium secondary battery, which has high battery voltage, light weight and high energy density, has promise as a battery for a hybrid vehicle. A secondary battery for a hybrid vehicle is required to store energy in the battery by regenerating energy at the time of slowdown of the vehicle and to assist acceleration of the vehicle by discharging this energy in high efficiency. In an application for the hybrid vehicle, a required battery property is an excellent output property for 10 seconds because the vehicle reaches to desired speed within ten-second acceleration. Therefore, reduction in battery resistance is required. Moreover, it is important to ensure safety because a lithium secondary battery for an automobile is a large battery.

It is reported that an olivine cathode material has low electron conductivity and has a low diffusion coefficient of lithium ions into a cathode material. In the olivine cathode material, a diffusion property of lithium ions can be improved by using a material with a high specific surface area. Moreover, conductivity can be added to the cathode material by carbon coating. By providing the carbon coating, a conductive network in the electrode can be configured and an output property of the battery suitable for a hybrid vehicle can be obtained. The carbon coating can suppress crystal growth together with the addition of the conductivity, contributing to providing a high specific surface area by forming smaller primary particles.

The inventors of the present invention have found that a conductive network and a diffusion property of lithium ions in the cathode can be improved and production of a high-output lithium secondary battery can be achieved by investigating a correlation between a primary particle diameter and a crystal orientation of a cathode active material in the cathode. An olivine cathode material has low electron conductivity and has a low diffusion coefficient of lithium ions into a cathode material. In order to put the olivine cathode material to practical use, the diffusion property of lithium ions is improved by making the material have a high specific surface area by forming particles with a smaller diameter and the conductivity is provided by the carbon coating, and thereby an output property is improved.

As described in Non-patent Document 1, diffusion of lithium ions in the olivine cathode material is one-dimensional diffusion from a direction of b axis of the crystal. Therefore, the inventors have focused attention on this property and have found that optimization of the relation between a moving direction of ions and a crystal structure is effective for improving the output property. Hereinafter, the optimization of the relation is described in detail. During discharge process of a lithium ion secondary battery, lithium ions are diffused into a cathode from an anode opposed to the cathode. When an active material in the cathode is the olivine cathode material, lithium ions move in a direction of b axis, diffusing in one dimension. Therefore, it is desirable that a crystal direction of b axis of the olivine cathode material in the cathode is oriented in a direction of the anode. When the olivine cathode material is thin in the direction of b axis and has a particle structure with a large aspect ratio, this olivine cathode material is preferable for ion diffusion to the cathode material. When the specific surface area of the olivine cathode material is high, a reaction area with an electrolyte solution is large. This is preferable for the ion diffusion. As described above, the lithium ion secondary battery having an excellent ion diffusion property and low electrode resistance can be obtained by controlling properties of the olivine cathode in the cathode for the lithium ion secondary battery.

The present invention relates to a cathode material and a cathode electrode for a lithium ion secondary battery containing a non-aqueous solvent, and a method for manufacturing the same, and more particularly relates to improvement of Li ion conductivity. The brief summary of the present invention is as follows.

In the cathode, a complex oxide including an olivine structure represented by a chemical formula LiₐMₓPO₄ (0≦a≦1.2, 0.9≦x≦1.1, and M is a transition metal including Fe or Mn) is included as a cathode material. Preferably, the cathode material has a specific surface area between 10 m²/g and 30 m²/g. The cathode material preferably has a primary particle diameter of between 20 nm and 200 nm, and an aspect ratio of primary particles ((length in a direction of a axis or c axis)/(thickness in a direction of b axis)) is 1.2 or more and 2.5 or less, and is particularly preferably 2.1 or more and 2.5 or less.

When X-ray diffraction peaks of the cathode for the secondary battery are measured, a diffraction peak intensity ratio (I₍₀₂₀₎/I₍₁₀₁₎) between (020) face and (101) face (Cu—Kα radiation is used as an X-ray source for the X-ray diffraction measurement) is preferably 3.55 or more and 4.2 or less, and more preferably 3.8 or more and 4.2 or less.

The cathode generally has a structure in which a mixed material including the cathode material, a binder and a conductive material is disposed in a form of a layer on a metal foil (a current collector). The cathode also may be manufactured by mixing a high density complex cathode material with the olivine cathode material, the conductive material and the binder and by depositing this complex cathode material on a substrate after the high density complex cathode material is previously prepared by mixing the cathode material, the binder and the conductive material.

The cathode described above is used for a lithium secondary battery and can be applied for devices that require high output, such as a hybrid vehicle and an industrial tool. The cathode is also used for producing a large lithium secondary battery and a battery module made by electrically connecting the plurality of lithium ion secondary batteries.

### [Cathode Material for Lithium Secondary Battery]

The inventors have found that resistance of a cathode is reduced by considering a primary particle diameter, a specific surface area, an aspect ratio, a crystalline orientation and a cathode density of the cathode that includes an olivine cathode material and is configured by the olivine cathode material. The olivine cathode material configuring the cathode for a lithium secondary battery is a complex oxide having an olivine structure that is represented by the chemical formula LiₐMₓPO₄ (0≦a≦1.2, 0.9≦x≦1.1, and M is a transition metal including Fe or Mn).

The olivine cathode material preferably has a primary particle diameter of between 20 nm and 200 nm. If the primary particle diameter is 20 nm or less, improvement of the cathode density and formation of the conductive network in the cathode cannot be achieved at the same time when the cathode is prepared. On the contrary, if the primary particle diameter exceeds 200 nm, a diffusion length of lithium ions is longer so that the electrode resistance is increased. Therefore, in order to obtain a high-output battery, the olivine cathode material preferably has the primary particle diameter of between 20 and 200 nm. The primary particles of the olivine cathode material in the cathode are evaluated by electron microscope observation of a cross-sectional surface or a fractured surface of the cathode.

The olivine cathode material preferably has a specific surface area of between 10 m²/g and 30 m²/g. When the specific surface area is less than 10 m²/g, the electrode resistance is increased because the reaction area of the cathode material and lithium ions is small. When the specific surface area exceeds 30 m²/g, improvement of the cathode density and formation of the conductive network in the cathode cannot be achieved at the same time. Particularly, when the olivine cathode material is used, the cathode has high resistance if the conductive network is not formed because the olivine cathode material has low electron conductivity. Consequently, in order to obtain a high-output battery, the olivine cathode material preferably has the specific surface area of between 10 m²/g and 30 m²/g.

A method for evaluating the specific surface area of the olivine cathode material is described below. The olivine cathode material is previously dried at 120° C. and packed into a sample cell. The sample cell is dried in nitrogen gas at 300° C. for 30 minutes. Subsequently, the sample cell is attached to a measurement part, and signals at the time of desorption with mixed gas of He and N₂ are counted. Subsequently, the specific surface area can be calculated by the BET method.

As a characteristic of the olivine cathode material suitable for producing high-output batteries, it is preferable to define an aspect ratio thereof. Since lithium ions are diffused from the direction of b axis in the olivine cathode material, it is desirable that the aspect ratio ((length in a direction of a axis or c axis)/(thickness in a direction of b axis)) is preferably 1.2 or more and 2.5 or less, and more preferably 2.1 or more and 2.5 or less. When the aspect ratio is less than 1.2, it is a disadvantage for diffusion of the lithium ions. When the aspect ratio is 2.6 or more, the improvement of the cathode density and the formation of the conductive network in the cathode cannot be achieved at the same time.

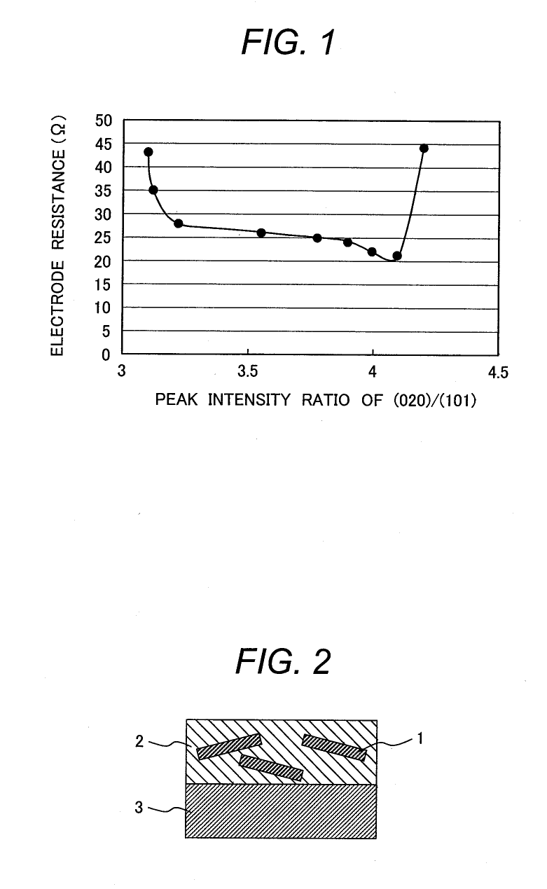

The inventors of the present invention prepared a slurry from the olivine cathode material, a conductive material and a binder, and then prepared a cathode by applying this slurry on an aluminum current collector. The obtained cathode was analyzed by X-ray diffraction, and an intensity ratio (I₍₀₂₀₎/I₍₁₀₁₎) of (020) peak and (101) peak was calculated from the obtained X-ray diffraction pattern. As a result, the inventors have found that there is a correlation between (I₍₀₂₀₎/I₍₁₀₁₎) of the cathode and electrode resistance of the cathode, as shown in FIG. 1. When the intensity ratio is 3.55 or more and 4.2 or less, reduction in electrode resistance is observed. Particularly, it is found that the intensity ratio is preferably 3.8 or more and 4.2 or less. From the subsequent investigation, the inventors have found that there is also a correlation between the cathode density and the intensity ratio of the peaks (I₍₀₂₀₎/I₍₁₀₁₎). By setting the cathode density to be 1.81 g/cm³ or more, the peak intensity ratio can be 3.55 or more.

Detailed description of a method of X-ray diffraction measurement is as follows. First, a sample is prepared by attaching the cathode on a glass sample plate. Subsequently, the sample is set in automatic X-ray diffraction apparatus (manufactured by Rigaku Corporation: RINT-Ultima III) and X-ray diffraction profile can be measured under the following conditions: radiation source is CuKα, X-ray tube voltage is 40 kV, X-ray tube current is 40 mA, scanning range is 10°≦2θ≦130°, scanning rate is 1.5°/min, sampling interval is 0.02°/step, diverging slit is 0.5°, scattering is slit 0.5° and receiving slit is 0.15 mm

When pressure at processing is simply increased during the preparation process of the cathode, an electrode may be peeled from the aluminum current collector. FIG. 2 is a view showing a cross-sectional structure of the cathode. With the cathode made by mixing a complex cathode material described in FIG. 2, this problem can be solved and the cathode is effective for a high-output battery.

The cathode made by mixing the complex cathode material has a locally high cathode density. The cathode is made by mixing particles of the complex cathode material, the particles of the complex cathode material is prepared by drying, densifying and grinding a slurry made of the cathode material, a conductive material and a binder.

First, the slurry is prepared from the olivine cathode material, the conductive material and the binder, and the slurry is applied onto a substrate (metal foil or resin tape) to form a cathode mixture layer, and then the cathode mixture layer is dried. Subsequently, the layer is densified by press processing or roll processing. The processing is performed until the cathode mixture layer is peeled from the substrate to obtain a flat complex cathode material 1. This flat complex cathode material 1 has an aspect ratio of secondary particles of 2.2 or more and less than 3.0. When the aspect ratio is less than 2.2, densification of the complex cathode material is insufficient. When the aspect ratio is 3.0 or more, unnecessary voids are formed in the cathode when the cathode is configured. This material is ball milled to form particles of the flat complex cathode material having a diameter of between 5 μm and 10 μm.

A slurry is prepared from the particles of the complex cathode material, the olivine cathode material, the conductive material and the binder. The slurry is applied on the aluminum current collector 3 as a mixture layer 2. After drying the mixture layer 2, roll processing is performed to obtain the cathode shown in FIG. 2. This cathode locally has high cathode density and has high (I₍₀₂₀₎/I₍₁₀₁₎). As a result, the cathode is effective for a high-output secondary battery.

### [Method for Manufacturing Olivine Cathode Material]

Finely ground iron oxalate dihydrate, ammonium dihydrogen phosphate and lithium carbonate are mixed in a molar ratio of 2:2:1.0. This mixture is pre-calcined at 300° C. under nitrogen atmosphere to obtain a precursor. Subsequently, the precursor and polyvinyl alcohol are mixed and are treated by heat at 700° C. for 8 hours under nitrogen atmosphere to obtain the olivine cathode material.

### [Lithium Ion Secondary Battery]

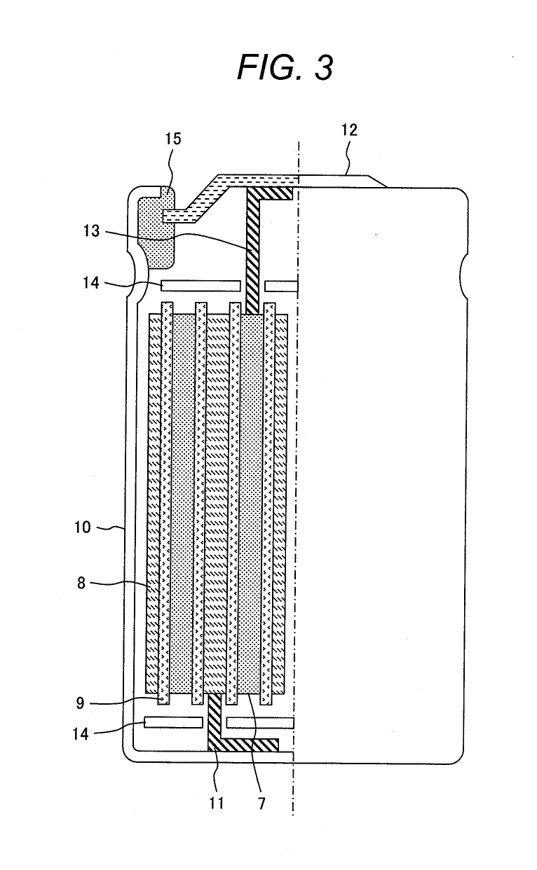

As a lithium ion secondary battery, various shapes, such as a cylindrical type, a laminated type, a coin type and a card type, have been known. The lithium ion secondary battery may be used for configuring a lithium ion battery module in which a plurality of the batteries are serially or parallelly connected. The cathode of the present invention can be applied for batteries having any shape. As an example, a partial cross-sectional view of a cylindrical lithium secondary battery is shown in FIG. 3. A cathode plate 7 and an anode plate 8 are stacked with a separator 9 between them and wound. This stacked body is contained in a battery can 10 and sealed with a lid 12. Lead pieces come out from each of the cathode and the anode and are connected to the lid and the battery can. Hereinafter, a method for manufacturing the cylindrical lithium ion secondary battery is described.

### 1) Method for Preparing Cathode

A conductive material such as acetylene black is added to the olivine cathode material and mixed. A cathode material having a high specific surface area such as the olivine cathode material used in the present invention has a high liquid-absorption property of an organic solvent used at the time of electrode preparation. Therefore, it is preferable that N-methyl-2-pyrrolidinone (hereinafter abbreviated as NMP), which is an organic solvent, is previously mixed with the cathode active material for the cathode active material to absorb NMP, and then the conductive material is dispersed into the cathode active material. Subsequently, a binder such as polyvinylidene fluoride (hereinafter abbreviated as PVDF) dissolved into a solvent such as NMP is added to this mixture and the resultant mixture is kneaded to obtain a cathode slurry. Subsequently, after applying this slurry onto an aluminum metal foil, the slurry is dried to prepare the cathode plate.

### 2) Method for Preparing Anode

A conductive material such as acetylene black and carbon fiber is added to an amorphous carbon material, which is an anode active material, and mixed. After adding PVDF dissolved in NMP or a rubber-based binder (such as SBR) to this mixture as a binder, the resultant mixture is kneaded to obtain an anode slurry. Subsequently, after applying this slurry onto a copper foil, the slurry is dried to prepare the anode plate.

### 3) Method for Forming Battery

The cathode plate and the anode plate are densified by roll processing and are cut into a desired shape to prepare electrodes. Subsequently, lead pieces for electric current are provided to these electrodes. A separator made of a porous insulating material is disposed between the cathode and the anode to form a stacked body. After winding this stacked body, the wound body is inserted into a battery can formed by stainless steel or aluminum. After connecting the lead pieces to the battery can, a non-aqueous electrolyte solution is poured into the battery can and finally the battery can is sealed to obtain a lithium ion secondary battery.

### EXAMPLES

Hereinafter, examples of the present invention are specifically described. These examples do not limit the scope of the present invention. First, various types of olivine cathode materials used in the examples were prepared.

### <Preparation of Olivine Cathode Material (1)>

Finely ground iron oxalate dihydrate, ammonium dihydrogen phosphate and lithium carbonate by a ball mill for 3 hours were mixed in a molar ratio of 2:2:1.0. This mixture was pre-calcined at 300° C. under nitrogen atmosphere to obtain a precursor. Subsequently, the precursor and polyvinyl alcohol were mixed and were treated by heat at 700° C. for 8 hours under nitrogen atmosphere to obtain the olivine cathode material (1) of LiFePO₄ that was covered with carbon. Here, an amount of the carbon that covered the olivine cathode material was 4% by weight.

Particles of the olivine cathode material (1) were observed by a transmission electron microscope in a viewing field at a magnification of 50000, and as a result, an average primary particle diameter was 20 nm. An aspect ratio of the primary particle was 1.2.

A specific surface area of the olivine cathode material (1) was measured. The material was previously dried at 120° C. and packed into a sample cell. The sample cell was dried in nitrogen gas at 300° C. for 30 minutes. Subsequently, the sample cell was attached to a measurement part, and signals at the time of desorption with mixed gas of He and N₂ were counted. Subsequently, the specific surface area was calculated by the BET method. As a result, the specific surface area of the olivine cathode material (1) was 30 m²/g.

### <Preparation of Olivine Cathode Material (2)>

Finely ground iron oxalate dihydrate, ammonium dihydrogen phosphate and lithium carbonate by a ball mill for 3 hours were mixed in a molar ratio of 2:2:1.0. This mixture was pre-calcined at 300° C. under nitrogen atmosphere to obtain a precursor. Subsequently, the precursor and polyvinyl alcohol were mixed and were treated by heat at 700° C. for 4 hours under nitrogen atmosphere to obtain the olivine cathode material (2) of LiFePO₄ that was covered with carbon. Here, an amount of the carbon that covered the olivine cathode material was 4% by weight.

As a result of observation by the same method as used in the case of the olivine cathode material (1), the olivine cathode material (2) had an average primary particle diameter of 10 nm, an aspect ratio of the primary particle of 1.2 and a specific surface area of 40 m²/g.

### <Preparation of Olivine Cathode Material (3)>

Finely ground iron oxalate dihydrate, ammonium dihydrogen phosphate and lithium carbonate by a ball mill for 3 hours were mixed in a molar ratio of 2:2:1.0. This mixture was pre-calcined at 300° C. under nitrogen atmosphere to obtain a precursor. Subsequently, the precursor and polyvinyl alcohol were mixed and were treated by heat at 700° C. for 12 hours under nitrogen atmosphere to obtain the olivine cathode material (3) of LiFePO₄ that was covered with carbon. Here, an amount of the carbon that covered the olivine cathode material was 4% by weight.

As a result of observation by the same method as used in the case of the olivine cathode material (1), the olivine cathode material (3) had an average primary particle diameter of 200 nm, an aspect ratio of the primary particle of 1.2 and a specific surface area of 10 m²/g.

### <Preparation of Olivine Cathode Material (4)>

Finely ground iron oxalate dihydrate, ammonium dihydrogen phosphate and lithium carbonate by a ball mill for 3 hours were mixed in a molar ratio of 2:2:1.0. This mixture was pre-calcined at 300° C. under nitrogen atmosphere to obtain a precursor. Subsequently, the precursor and polyvinyl alcohol were mixed and were treated by heat at 700° C. for 20 hours under nitrogen atmosphere to obtain the olivine cathode material (4) of LiFePO₄ that was covered with carbon. Here, an amount of the carbon that covered the olivine cathode material was 4% by weight.

As a result of observation by the same method as used in the case of the olivine cathode material (1), the olivine cathode material (4) had an average primary particle diameter of 210 nm, an aspect ratio of the primary particle of 1.2 and a specific surface area of 9 m²/g.

### <Preparation of Olivine Cathode Material (5)>

Finely ground iron oxalate dihydrate, ammonium dihydrogen phosphate and lithium carbonate by a ball mill for 3 hours were mixed in a molar ratio of 2:2:1.05. This mixture was pre-calcined at 300° C. under nitrogen atmosphere to obtain a precursor. Subsequently, the precursor and polyvinyl alcohol were mixed and were treated by heat at 700° C. for 8 hours under nitrogen atmosphere to obtain the olivine cathode material (5) of LiFePO₄ that was covered with carbon. Here, an amount of the carbon that covered the olivine cathode material was 4% by weight.

As a result of observation by the same method as used in the case of the olivine cathode material (1), the olivine cathode material (5) had an average primary particle diameter of 20 nm, an aspect ratio of the primary particle of 2.1 and a specific surface area of 30 m²/g.

### <Preparation of Olivine Cathode Material (6)>

Finely ground iron oxalate dihydrate, ammonium dihydrogen phosphate and lithium carbonate by a ball mill for 3 hours were mixed in a molar ratio of 2:2:1.1. This mixture was pre-calcined at 300° C. under nitrogen atmosphere to obtain a precursor. Subsequently, the precursor and polyvinyl alcohol were mixed and were treated by heat at 700° C. for 8 hours under nitrogen atmosphere to obtain the olivine cathode material (6) of LiFePO₄ that was covered with carbon. Here, an amount of the carbon that covered the olivine cathode material was 4% by weight.

As a result of observation by the same method as used in the case of the olivine cathode material (1), the olivine cathode material (6) had an average primary particle diameter of 20 nm, an aspect ratio of the primary particle of 2.5 and a specific surface area of 30 m²/g.

### <Preparation of Olivine Cathode Material (7)>

Finely ground iron oxalate dihydrate, ammonium dihydrogen phosphate and lithium carbonate by a ball mill for 3 hours were mixed in a molar ratio of 2:2:1.0. This mixture was pre-calcined at 300° C. under nitrogen atmosphere to obtain a precursor. Subsequently, the precursor and polyvinyl alcohol were mixed and were treated by heat at 650° C. for 8 hours under nitrogen atmosphere to obtain the olivine cathode material (7) of LiFePO₄ that was covered with carbon. Here, an amount of the carbon that covered the olivine cathode material was 4% by weight.

As a result of observation by the same method as used in the case of the olivine cathode material (1), the olivine cathode material (7) had an average primary particle diameter of 18 nm. An aspect ratio of the primary particle was 1.1. A specific surface area of the olivine cathode material (7) was 35 m²/g.

### <Preparation of Olivine Cathode Material (8)>

Finely ground iron oxalate dihydrate, ammonium dihydrogen phosphate and lithium carbonate by a ball mill for 3 hours were mixed in a molar ratio of 2:2:1.15. This mixture was pre-calcined at 300° C. under nitrogen atmosphere to obtain a precursor. Subsequently, the precursor and polyvinyl alcohol were mixed and were treated by heat at 650° C. for 8 hours under nitrogen atmosphere to obtain the olivine cathode material (8) of LiFePO₄ that was covered with carbon. Here, an amount of the carbon that covered the olivine cathode material was 4% by weight.

As a result of observation by the same method as used in the case of the olivine cathode material (1), an average primary particle diameter was 200 nm. An aspect ratio of the primary particle was 2.6. A specific surface area of the olivine cathode material (8) was 10 m²/g.

### <Preparation of Olivine Cathode Material (9)>

Finely ground iron oxalate dihydrate, manganese carbonate, ammonium dihydrogen phosphate and lithium carbonate by a ball mill for 3 hours were mixed in a molar ratio of 1.6:0.4:2:1.0. This mixture was pre-calcined at 300° C. under nitrogen atmosphere to obtain a precursor. Subsequently, the precursor and polyvinyl alcohol were mixed and were treated by heat at 700° C. for 8 hours under nitrogen atmosphere to obtain the olivine cathode material (9) of LiFeMnPO₄ that was covered with carbon. Here, an amount of the carbon that covered the olivine cathode material was 4% by weight.

As a result of observation by the same method as used in the case of the olivine cathode material (1), the olivine cathode material (9) had an average primary particle diameter of 40 nm. An aspect ratio of the primary particle was 1.2. A specific surface area was 25 m²/g.

TABLE 1

| | | | | Primary | Aspect | Specific |
|---|---|---|---|---|---|---|
| | Composition ratio | | | particle | ratio of | surface |
| | (atomic ratio %) | | | diameter | primary | area |
| | Li | Fe | Mn | (nm) | particles | (m²/g) |
| Olivine cathode | 1.00 | 1 | 0 | 20 | 1.2 | 30 |
| material (1) | | | | | | |
| Olivine cathode | 1.00 | 1 | 0 | 10 | 1.2 | 40 |
| material (2) | | | | | | |
| Olivine cathode | 1.00 | 1 | 0 | 200 | 1.2 | 10 |
| material (3) | | | | | | |
| Olivine cathode | 1.00 | 1 | 0 | 210 | 1.2 | 9 |
| material (4) | | | | | | |
| Olivine cathode | 1.05 | 1 | 0 | 20 | 2.1 | 30 |
| material (5) | | | | | | |
| Olivine cathode | 1.10 | 1 | 0 | 20 | 2.5 | 30 |
| material (6) | | | | | | |
| Olivine cathode | 1.00 | 1 | 0 | 18 | 1.1 | 35 |
| material (7) | | | | | | |
| Olivine cathode | 1.15 | 1 | 0 | 200 | 2.6 | 10 |
| material (8) | | | | | | |
| Olivine cathode | 1.00 | 0.8 | 0.2 | 40 | 1.2 | 25 |
| material (9) | | | | | | |

Cathodes of lithium ion secondary batteries in the examples and comparative examples were prepared by using the olivine cathode materials (1) to (9).

### Example 1

A cathode plate was prepared in the following procedure by using the olivine cathode material (1).

A cathode mixture slurry was prepared by mixing a solution in which PVDF as a binder was previously dissolved in NMP as a solvent, the olivine cathode material (1) and a carbon-based conductive material having an average particle diameter of 35 nm. The olivine cathode material (1), the carbon-based conductive material and the binder were mixed in a weight percent ratio of 85:5:10. After this slurry was uniformly applied onto an aluminum sheet having a thickness of 20 μm, the slurry was dried at 100° C. and compressed at 1.5 ton/cm² by a press machine to form a coating film having a thickness of about 100 μm, and thereby a cathode plate 7 was obtained. An electrode density of the cathode plate was 1.81 g/cm³. The X-ray diffraction was performed on the cathode plate 7 to calculate a peak intensity ratio of (020)/(101). The peak intensity ratio of (020)/(101) was 3.55.

Subsequently, a battery for test was prepared by using the cathode plate. The cathode plate 7 was punched out in a diameter of 15 mm. The punched cathode plate was used as a cathode and metal lithium was used as a counter electrode and a reference electrode. A mixed solvent of ethyl carbonate and dimethyl carbonate in which 1.0 mol of LiPF₆ was dissolved as an electrolyte was used as an electrolyte solution.

### <Measurement of Resistance Value>

This battery for test was initialized by repeating charge and discharge at 0.3C to an upper limit voltage of 3.6V and a lower limit voltage of 2.0V for three times. Moreover, charge at constant current and constant voltage was performed at equivalent to 0.3C to the upper limit voltage of 3.6V for 5 hours. Subsequently, constant current discharge was performed at equivalent to 1C to the lower limit voltage of 2.0V. Open-circuit voltage before the discharge and voltage after 10 seconds of the discharge were measured, and voltage drop (ΔV), which is a difference between both of the voltages, was calculated. In addition, after the discharge current was changed to equivalent to 3C and 6C, voltage drop of each discharge current (I) was measured by performing similar charge and discharge. The discharge current (I) and voltage drop (ΔV) were plotted. Electrode resistance at an open circuit voltage of 3.42V was calculated from the slope of the plot. As a result, the electrode resistance was 26Ω, so that a low resistance lithium ion secondary battery was obtained.

### <Preparation of Cylindrical Battery>

By combining the cathode plate and an anode plate, a cylindrical battery schematically shown in FIG. 4 was prepared by the following procedure.

The cathode plate 7 including the olivine cathode material (1) was cut in an applied width of 5.4 cm and an applied length of 60 cm. In order to take out electric current, a lead piece made from an aluminum foil was welded to prepare a cathode plate.

Subsequently, the anode plate was prepared. A graphite carbon material as an anode active material was dissolved into NMP as a binder and mixed to prepare an anode mixture slurry. Dry weight ratio of the graphite carbon material and the binder was set to 92:8. This slurry was uniformly applied to a rolled copper foil having a thickness of 10 μm. Subsequently, compression molding was performed by a roll press machine. The obtained sample was cut in an applied width of 5.6 cm and an applied length of 64 cm. A lead piece made from a copper foil was welded to prepare the anode plate.

A separator 9 was disposed between the cathode plate 7 and the anode plate 8 so that the cathode plate 7 and the anode plate 8 were not directly contact with each other, and the obtained sample was wound to prepare an electrode group. A porous polypropylene film having a thickness of 25 μm and a width of 5.8 cm was used as the separator 9. The lead piece 13 of the cathode plate and the lead piece 11 of the anode plate were located at the opposite ends of the electrode group to each other. When the cathode plate 7 and the anode plate 8 were arranged, the mixture applied part of the cathode was not protruded from the mixture applied part of the anode.

Subsequently, the electrode group was inserted into a battery can 10 made of SUS, and the anode lead piece 11 was welded to a bottom part of the can. The cathode lead piece 13 was welded to a sealing lid part 12 that also acted as a cathode current terminal. A non-aqueous electrolyte solution (a solution of LiPF₆ of 1.0 mole/litter in a mixed solvent of ethylene carbonate (EC) and dimethyl carbonate (DMC) of 1:2 in a volume ratio) was poured into the battery can 10 in which the electrode group was inserted. Subsequently, the sealing lid part 12 to which a gasket 15 was attached was swaged to the battery can 10, sealing the battery can to prepare a cylindrical battery having a diameter of 18 mm and a length of 65 mm. The sealing lid part 12 had a rupture valve that was ruptured to release the pressure within the battery when pressure was raised in the battery. An insulating plate 14 was arranged between the sealing lid part 12 and the electrode group.

### <Evaluation of Cylindrical Battery>

This small cylindrical battery was initialized by repeating charge and discharge at 0.3C to an upper limit voltage of 3.6 V and a lower limit voltage of 2.0 V for three times. In addition, charge and discharge at 0.3C to the upper limit voltage of 3.6 V and the lower limit voltage of 2.0 V was performed to measure a discharge capacity of the battery. Moreover, charge at constant current and constant voltage was performed at equivalent to 0.3C to the upper limit voltage of 3.6 V for hours. Subsequently, constant current discharge was performed at equivalent to 1C to the lower limit voltage of 2.0 V. Open-circuit voltage before the discharge and voltage after 10 seconds of the discharge were measured, and voltage drop (ΔV), which is a difference between both of the voltages, was calculated. In addition, after the discharge current was changed to equivalent to 3C and 6C, voltage drop of each discharge current (I) was measured by performing similar charge and discharge. The discharge current (I) and voltage drop (ΔV) were plotted. A battery resistance at an open circuit voltage of 3.42 V was calculated from the slope of the plot.

As a result, the resistance of the cylindrical battery in Example 1 was 56 mΩ. As a result of finding a battery output from the open circuit voltage and the battery resistance at a charge state of the battery of 50%, a high-output battery of 35 W was obtained. In addition, a battery module was prepared by serially connecting ten of these batteries. By forming the battery module including the smaller number of the cylindrical batteries of this example, output that satisfied a required specification was obtained. The battery module including the lithium ion secondary batteries of this example can be a high-output module.

### Example 2

A cathode plate, was prepared by using the olivine cathode material (1) by the same method as in Example 1 except that the electrode density was set to 1.85 g/cm³. The X-ray diffraction was performed in the same way as in Example 1 and a peak intensity ratio of (020)/(101) was calculated to be 3.8.

Electrode resistance was evaluated by the same way as in Example 1 to be 25Ω, which was low resistance. A high-output secondary battery also can be provided when the cathode material in Example 2 was applied.

### Comparative Example 1

A cathode plate was prepared by using the olivine cathode material (1) by the same method as in Example 1 except that the electrode density was set to 1.6 g/cm³. The X-ray diffraction was performed in the same way as in Example 1 and a peak intensity ratio of (020)/(101) was calculated to be 3.1.

Electrode resistance was evaluated by the same way as in Example 1 to be 35Ω, which was high resistance.

### Comparative Example 2

A cathode plate was prepared by using the olivine cathode material (1) by the same method as in Example 1 except that the electrode density was set to 2.0 g/cm³. The density was changed by changing pressure in consolidation processing. The pressure was set to 1.5 ton/cm² in Example 1 and 1.2 ton/cm² in Comparative Examples. The X-ray diffraction was performed in the same way as in Example 1 and a peak intensity ratio of (020)/(101) was calculated to be 4.1. Electrode resistance was evaluated by the same way as in Example 1 to be 44Ω, which was high resistance. Microcracks were generated in the electrode because of the electrode density of 2.0 g/cm³. Therefore, desired low resistance was not attained.

### Comparative Example 3

A cathode plate was prepared by using the olivine cathode material (2) by the same method as in Example 1. The electrode density of the cathode plate 7 was set to 1.7 g/cm³. The X-ray diffraction of the cathode plate 7 was performed and a peak intensity ratio of (020)/(101) was calculated to be 3.2. A battery for test similar to the battery in Example 1 was prepared and an electrode resistance at an open-circuit voltage of 3.42 V was calculated to be 34Ω, which was high resistance.

### Example 3

A cathode plate was prepared by using the olivine cathode material (3) by the same method as in Example 1. The electrode density of the cathode plate was set to 1.81 g/cm³. The X-ray diffraction of the cathode plate 7 was performed and a peak intensity ratio of (020)/(101) was calculated to be 3.55.

A battery for test similar to the battery in Example 1 was prepared and an electrode resistance at an open-circuit voltage of 3.42 V was calculated to be 27Ω, which was low resistance. A high-output secondary battery also can be provided when the cathode material in Example 3 was applied.

### Comparative Example 4

A cathode plate was prepared by using the olivine cathode material (4) by the same method as in Example 1. The electrode density of the cathode plate was set to 1.81 g/cm³. The X-ray diffraction of the cathode plate 7 was performed and a peak intensity ratio of (020)/(101) was calculated to be 3.2.

A battery for test similar to the battery in Example 1 was prepared and an electrode resistance at an open-circuit voltage of 3.42 V was calculated to be 34Ω, which was high resistance.

### Example 4

A cathode plate was prepared by using the olivine cathode material (5) by the same method as in Example 1. The electrode density of the cathode plate was set to 1.81 g/cm³. The X-ray diffraction of the cathode plate 7 was performed and a peak intensity ratio of (020)/(101) was calculated to be 4.

A battery for test similar to the battery in Example 1 was prepared and an electrode resistance at an open-circuit voltage of 3.42 V was calculated to be 22Ω, which was low resistance. A high-output secondary battery also can be provided when the cathode material in Example 4 is applied.

### Example 5

In this example, a density of the electrode in Example 4 was varied.

A cathode plate was prepared by using the olivine cathode material (5) by the same method as in Example 1. The electrode density of the cathode plate was set to 1.85 g/cm³. The X-ray diffraction was performed and a peak intensity ratio of (020)/(101) was calculated to be 4.1.

A battery for test similar to the battery in Example 1 was prepared and an electrode resistance at an open-circuit voltage of 3.42 V was calculated to be 21Ω, which was low resistance. A high-output secondary battery also can be provided when the cathode material in Example 5 is applied.

### Example 6

A cathode plate was prepared by using the olivine cathode material (6) by the same method as in Example 1. The electrode density of the cathode plate was set to 1.81 g/cm³. The X-ray diffraction of the cathode plate 7 was performed and a peak intensity ratio of (020)/(101) was calculated to be 4.1.

A battery for test similar to the battery in Example 1 was prepared and an electrode resistance at an open-circuit voltage of 3.42 V was calculated to be 21Ω, which was low resistance. A high-output secondary battery also can be provided when the cathode material in Example 6 is applied.

### Comparative Example 5

A cathode plate was prepared by using the olivine cathode material (7) by the same method as in Example 1. The electrode density of the cathode plate was set to 1.7 g/cm³. The X-ray diffraction of the cathode plate 7 was performed and a peak intensity ratio of (020)/(101) was calculated to be 3.1.

A battery for test similar to the battery in Example 1 was prepared and an electrode resistance at an open-circuit voltage of 3.42 V was calculated to be 44Ω, which was high resistance.

### Comparative Example 6

A cathode plate was prepared by using the olivine cathode material (8) by the same method as in Example 1. The electrode density of the cathode plate was set to 1.6 g/cm³. The X-ray diffraction of the cathode plate 7 was performed and a peak intensity ratio of (020)/(101) was calculated to be 3.1.

A battery for test similar to the battery in Example 1 was prepared and an electrode resistance at an open-circuit voltage of 3.42 V was calculated to be 44Ω, which was high resistance.

### Example 7

In this example, complex particles including the cathode mixture are mixed into a part of the cathode.

First, the complex particles were prepared. A slurry was prepared with the olivine cathode material (1), the conductive material and the binder in a weight percent of 85:5:10. The slurry was applied onto an aluminum substrate to form a cathode mixture layer having a thickness of 50 μm, and then the layer was dried at 120° C. Subsequently, the sample was densified at a pressure of 1.5 ton/cm² by press processing. The processing was performed until the cathode mixture layer was peeled from the substrate to obtain a complex cathode material. The complex cathode material was ball milled to form flat complex cathode material particles having a particle diameter of between 5 and 10 μm. This flat complex cathode material had an aspect ratio of secondary particles of 2.2.

After mixing the flat complex cathode material particles and the olivine cathode material (1) in an equimolar ratio on Fe element basis, a slurry was prepared by mixing the conductive material and the binder. The slurry was applied onto an aluminum current collector, dried and then roll processed to obtain a cathode material which was mixed with the flat complex cathode material. The composition in the cathode was adjusted in a mixing ratio of the cathode material, the conductive material and the binder of 85:5:10. The density of the electrode was measured to be 1.9 g/cm³. The X-ray diffraction was performed in the same way as in Example 1 and a peak intensity ratio of (020)/(101) was calculated to be 4.

Electrode resistance was evaluated by the same way as in Example 1 to be 22Ω, which was low resistance. A high-output secondary battery also can be provided when the cathode material in Example 7 is applied.

### Example 8

In this example, similar to Example 7, complex particles including the cathode mixture are mixed into a part of the cathode.

A slurry was prepared with the olivine cathode material (1), the conductive material and the binder in a weight percent of 85:5:10. The slurry was applied onto an aluminum substrate to form a cathode mixture layer having a thickness of 50 μm, and then the layer was dried at 120° C. Subsequently, the complex particles of this example were densified at a pressure of 1.7 ton/cm² by press processing. Similar to Example 7, the processing was performed until the cathode mixture layer was peeled from the substrate to obtain a complex cathode material.

The complex cathode material was ball milled to form flat complex cathode material particles having a particle diameter of between 5 and 10 μm. The flat complex cathode material of this example had an aspect ratio of secondary particles of 3.0.

By processing in a similar way to Example 7, a cathode which was mixed with the flat complex cathode material was obtained. The X-ray diffraction was performed in the same way as in Example 1 and a peak intensity ratio of (020)/(101) was calculated to be 4.1.

Electrode resistance was evaluated by the same way as in Example 1 to be 21Ω, which was low resistance. A high-output secondary battery also can be provided when the cathode material in Example 7 is applied.

### Comparative Example 7

In this comparative example, similar to Example 7, complex particles including the cathode mixture are mixed into a part of the cathode. A slurry was prepared with the olivine cathode material (1), the conductive material and the binder in a weight percent of 85:5:10. The slurry was applied onto an aluminum substrate to form a cathode mixture layer having a thickness of 50 μm, and then the layer was dried at 120° C. Subsequently, the sample was densified at a pressure of 1.2 ton/cm² by press processing. The processing was performed until the cathode mixture layer was peeled from the substrate to obtain a complex cathode material. The complex cathode material was ball milled to form flat complex cathode material particles having a particle diameter of between 5 and 10 μm. This flat complex cathode material had an aspect ratio of secondary particles of 2.1.

Moreover, similar to Example 7, a slurry was prepared with this material, the olivine cathode material (1), the conductive material and the binder. This mixture layer was applied onto the aluminum current collector. After drying the mixture layer, press processing at a pressure of 1.5 ton/cm² was performed to obtain a flat complex material cathode having an electrode density of 1.85 g/cm³. The X-ray diffraction was performed in the same way as in Example 1 and a peak intensity ratio of (020)/(101) was calculated to be 3.8.

The test battery including the obtained cathode was evaluated in a similar way to Example 1. As a result, the electrode resistance was 30Ω, which was high resistance. With this electrode, density of the complex material was locally high, and desired low resistance of the electrode cannot be attained.

### Comparative Example 8

In this comparative example, similar to Example 7, complex particles including the cathode mixture are mixed into a part of the cathode.

A slurry was prepared with the olivine cathode material (1), the conductive material and the binder in a weight percent of 85:5:10. The slurry was applied onto an aluminum substrate to form a cathode mixture layer having a thickness of 50 μm, and then the layer was dried at 120° C. Subsequently, the sample was densified at a pressure of 1.9 ton/cm² by press processing. The processing was performed until the cathode mixture layer was peeled from the substrate to obtain a flat complex cathode material. This material was ball milled to form flat complex cathode material particles having a particle diameter of between 5 and 10 μm. This flat complex cathode material had an aspect ratio of secondary particles of 3.1.

Similar to Example 7, a slurry was prepared with the complex cathode material particles, the olivine cathode material (1), the conductive material and the binder. This slurry was applied onto the aluminum current collector as a mixture layer. After drying the mixture layer, press processing at a pressure of 1.5 ton/cm² was performed to obtain a flat complex material cathode having an electrode density of 1.6 g/cm³. Although density was locally high, the whole cathode did not have high electrode density because the aspect ratio was too high. The X-ray diffraction was performed in the same way as in Example 1 and a peak intensity ratio of (020)/(101) was calculated to be 4.1.

The test battery including the obtained cathode was evaluated in a similar way to Example 1. As a result, the electrode resistance was 44Ω, which was high resistance because of the low electrode density.

### Example 9

A cathode plate was prepared by using the olivine cathode material (9) by the same method as in Example 1. The electrode density of the cathode plate 7 was set to 1.81 g/cm³. The X-ray diffraction of the cathode plate 7 was performed and a peak intensity ratio of (020)/(101) was calculated to be 3.6.

A battery for test similar to the battery in Example 1 was prepared and an electrode resistance at an open-circuit voltage of 3.42 V was calculated to be 29Ω, which was low resistance. A high-output secondary battery also can be provided when the cathode material in Example 9 is applied.

TABLE 2

| | | | Peak | Aspect | |
|---|---|---|---|---|---|
| | Olivine | Electrode | intensity | ratio of | Electrode |
| | cathode | density | ratio of | complex | resistance |
| | material | (g/cm³) | (020)/(101) | particles | (Ω) |
| Example 1 | (1) | 1.81 | 3.55 | | 26 |
| Example 2 | (1) | 1.85 | 3.8 | | 25 |
| Comparative | (1) | 1.6 | 3.1 | | 35 |
| Example 1 | | | | | |
| Comparative | (1) | 2.0 | 4.1 | | 44 |
| Example 2 | | | | | |
| Comparative | (2) | 1.7 | 3.2 | | 34 |
| Example 3 | | | | | |
| Example 3 | (3) | 1.81 | 3.55 | | 27 |
| Comparative | (4) | 1.81 | 3.2 | | 34 |
| Example 4 | | | | | |
| Example 4 | (5) | 1.81 | 4 | | 22 |
| Example 5 | (5) | 1.85 | 4.1 | | 21 |
| Example 6 | (6) | 1.81 | 4.1 | | 21 |
| Comparative | (7) | 1.7 | 3.1 | | 44 |
| Example 5 | | | | | |
| Comparative | (8) | 1.6 | 3.1 | | 44 |
| Example 6 | | | | | |
| Example 7 | (1) | 1.9 | 4 | 2.2 | 22 |
| Example 8 | (1) | 2 | 4.1 | 3.0 | 21 |
| Comparative | (1) | 1.85 | 3.8 | 2.1 | 30 |
| Example 7 | | | | | |
| Comparative | (1) | 1.6 | 4.1 | 3.1 | 44 |
| Example 8 | | | | | |
| Example 9 | (9) | 1.81 | 3.6 | | 29 |

### INDUSTRIAL APPLICABILITY

The cathode material for a lithium secondary battery of the present invention has a low electrode resistance and can contribute to produce a high-output secondary battery. Therefore, the cathode is suitable for products requiring high output, such as a secondary battery for a hybrid vehicle and a secondary battery for an industrial tool.

### DESCRIPTION OF THE REFERENCE NUMERALS

1 High Density Flat Active Material
2 Mixture Layer
3 Aluminum Current Collector
7 Cathode Plate
8 Anode Plate
9 Separator
10 Battery Can
11 Lead Piece of Anode Plate
12 Sealing Lid Part
13 Lead Piece of Cathode Plate
14 Insulating Plate
15 Gasket

1. A cathode for a lithium ion secondary battery, the cathode comprising a cathode mixture layer,
wherein the cathode mixture layer includes a cathode material in which a complex oxide having an olivine structure represented by a chemical formula LiₐMₓPO₄ (0<a≦1.2, 0.9≦x≦1.1, and M is a transition metal including Fe or Mn) is covered with carbon, a conductive material, and a binder,
wherein a diffraction peak intensity ratio (I₍₀₂₀₎/I₍₁₀₁₎) between a (020) face and a (101) face of the cathode measured by X-ray diffraction is 3.55 or more and 4.2 or less, and
wherein a density of the cathode is 1.81 g/cm³ or more and less than 2.0 g/cm³.

2. The cathode for a lithium ion secondary battery according to claim 1,
wherein the diffraction peak intensity ratio (I₍₀₂₀₎/I₍₁₀₁₎) is 3.8 or more and 4.2 or less.

3. The cathode for a lithium ion secondary battery according to claim 1,
wherein the cathode material has a specific surface area of between 10 m²/g and 30 m²/g.

4. The cathode for a lithium ion secondary battery according to claim 1,
wherein the cathode material has a primary particle diameter of between 20 nm and 200 nm.

5. The cathode for a lithium ion secondary battery according to claim 1,
wherein a primary particle of the cathode material has a ratio of a length in a direction of a axis or c axis to a thickness in a direction of b axis, the ratio being 1.2 or more and 2.5 or less.

6. The cathode for a lithium ion secondary battery according to claim 1,
wherein a primary particle of the cathode material has a ratio of a length in a direction of a axis or c axis to a thickness in a direction of b axis, the ratio being 2.1 or more and 2.5 or less.

7. (canceled)

8. The cathode for a lithium ion secondary battery according to claim 1,
wherein the cathode material is covered with a carbon material.

9. A secondary battery comprising:
a cathode and an anode which store and release lithium ions, and
an electrolyte solution containing a non-aqueous solvent,
wherein the cathode is the cathode according to claim 1.

10. A battery module comprising:
a plurality of the secondary batteries according to claim 9, the a plurality of the secondary batteries being electrically connected with each other.

11. A method for manufacturing a cathode for a lithium ion secondary battery according to claim 1, the cathode including a complex oxide having an olivine structure represented by a chemical formula LiₐMₓPO₄ (0<a≦1.2, 0.9≦x≦1.1, and M is a transition metal including Fe or Mn), the method comprising the steps of:
configuring a complex cathode material by mixing the complex oxide, a conductive material, and a binder;
configuring a cathode mixture slurry by mixing the complex cathode material, an additional cathode material, the conductive material, and the binder; and
applying the cathode mixture slurry onto a current collector.
